(19) United States
(12) Patent Application Publication
(10) Pub. No.: US 2026/0085207 A1
(43) Pub. Date: Mar. 26, 2026

(54) MAR AND SCUFF RESISTANT ARCHITECTURAL COATING

(71) Applicant: BASF SE, Ludwigshafen am Rhein (DE)

(72) Inventor: Kaliappa RAGUNATHAN, Charlotte, NC (US)

(21) Appl. No.: 19/112,613

(22) PCT Filed: Sep. 19, 2023
(86) PCT No.: PCT/US2023/033156

§ 371 Date: Mar. 18, 2025

Related U.S. Application Data
(60) Provisional application No. 63/407,738, filed on Sep. 19, 2022.

(51) Int. Cl. C09D 133/26; C08F 8/30; C09D 4/00; C09D 5/02

(52) U.S. Cl. CPC C09D 133/26; C08F 8/30; C09D 4/00; C09D 5/022; C08F 2810/20; C08F 2810/50

(57) ABSTRACT

The present disclosure provides architectural coatings containing aqueous self-crosslinking polymers. The coatings provide solutions to the problems of scuffing and marring of paint films in high traffic areas and tight spaces.

### FIELD OF THE DISCLOSURE

The present disclosure is generally related to the field of aqueous architectural coating compositions, in particular, self-crosslinking coating compositions with mar and scuff resistance, and to their methods of making and their uses in various architectural applications.

### BACKGROUND OF THE DISCLOSURE

Aqueous architectural coatings such as paints that cover interior walls can commonly become marred, stained, or scuffed as the result of everyday traffic in the area where the coating composition was applied. These discrepancies may be caused by contact from people or objects such as shoes, or furniture during office moves. These objects may leave undesirable scuff marks on the walls either by removing a layer of paint or by leaving a residue on the paint surface. Attempts to minimize marring and scuffing have not been fully satisfactory, and walls in high traffic areas need to be repainted frequently.

### SUMMARY OF THE DISCLOSURE

Disclosed are architectural coatings which contain polymer dispersions comprised of the self-crosslinking monomers diacetone acrylamide and adipic dihydrazide. Once formulated into semi-gloss architectural coatings, these polymer dispersions improve the scuff and mar resistance of the coatings

In a first form thereof, the present disclosure provides a polymer emulsion composition with a first and second stage comprising ketone or aldehyde group containing monomers and a polyhydrazide containing crosslinker, wherein the ketone to hydrazide functional group equivalent ratio is in the range of 1:0.6 to 1:1.5.

In a second form thereof, the present disclosure provides the polymer composition of form 1, wherein the ketone containing monomers comprise diacetone acrylamide.

In a third form thereof, the present disclosure provides the polymer composition of form 1, wherein the hydrazide containing cross-linker comprise adipic dihydrazide.

In a fourth form thereof, the present disclosure provides the polymer composition of form 2, wherein the diacetone acrylamide monomers are present in an amount of 2.5 wt. % or greater based on the total weight of the composition.

In a fifth form thereof, the present disclosure provides the polymer composition of form 3, wherein the adipic dihydrazide or polyhydrazide cross linkers are present in an amount of 0.8 wt. % or greater based on the total weight of the composition.

In a sixth form thereof, the present disclosure provides the polymer composition of any of forms 1-5, wherein the composition further comprises monomers selected from the group consisting of methyl (meth)acrylate, 2-ethyl (meth)acrylate, n-butyl (meth)acrylate, t-butyl (meth)acrylate, i-butyl (meth)acrylate, cyclohexyl(meth)acrylate, 2-ethylhexyl (meth)acrylate, i-bornyl(meth)acrylate, 2-octyl(meth)acrylate, styrene, (meth)acrylic acid, itaconic acid, sulfur acid monomers and phosphorous acid monomers.

In a seventh form thereof, the present disclosure provides the polymer composition of any of forms 1-6, wherein the weight ratio of the first stage polymer to the second stage polymer is from 50:50 to 97.5:2.5.

In an eighth form thereof, the present disclosure provides the polymer composition of any of forms 1-7, wherein the second stage polymer is present in an amount from 2.5 wt. % to 40 wt. % based on the total weight of the composition.

In a ninth form thereof, the present disclosure provides the polymer composition of any of forms 1-8, wherein the first stage polymer has a theoretical T_{g} of from −100° C. to 50° C.

In a tenth form thereof, the present disclosure provides the polymer composition of any of forms 1-9, wherein the second stage polymer has a theoretical T_{g} of from −50° C. to 250° C.

In an eleventh form thereof, the present disclosure provides the polymer composition of any of forms 1-10, wherein the weight % ratio of the aldehyde or keto monomer of the first stage polymer to the second stage polymer is 0.7 to 2.5 based on the total monomer weight of the respective stages.

In a twelfth form thereof, the present disclosure provides an architectural coating composition comprising the polymer composition of any of forms 1-11.

In a thirteenth form thereof, the present disclosure provides the architectural coating composition of form 11, further comprising one or more of pigments, dispersants, fillers, coalescents, pH modifying agents, plasticizers, defoamers, surfactants, thickeners, biocides, co-solvents, and combinations thereof.

In a fourteenth form thereof, the present disclosure provides the architectural coating composition of claim 11 or claim 12, wherein the coating composition demonstrates at least one of the following properties: (i) mar resistance when scraped with a plastic spoon, (ii) mar resistance when scraped with a plastic fork, or (iii) scuff resistance when scraped with a rubber shoe sole as measured by a visual rating of the damage done to the coating.

In a fifteenth form thereof, the present disclosure provides a method of producing the multi-stage polymer emulsion composition of any preceding claim, the method comprising: (i) producing a first stage polymer from a first pre-emulsion of monomers and initiator and (ii) producing a second stage polymer from a second pre-emulsion of monomers by feeding the second stage monomer pre-emulsion into the first stage polymer dispersion in the presence of a free radical polymerization initiator.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure.

FIG. 1 provides the pendulum swing equipment used to test the scuff resistance of the architectural coatings.

### DETAILED DESCRIPTION

### I. Definitions

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments and are also disclosed. As used in this disclosure and in the appended claims, the singular forms “a”, “an”, “the”, include plural referents unless the context clearly dictates otherwise. The disclosure of percentage ranges and other ranges herein includes the disclosure of the endpoints of the range and any integers provided in the range.

As used herein, an “aqueous medium” refers to a liquid medium comprising at least 50 wt. % water, based on the total weight of the liquid medium. Such aqueous liquid mediums can for example comprise at least 60 wt. % water, or at least 70 wt. % water, or at least 80 wt. % water, or at least 90 wt. % water, or at least 95 wt. % water, or 100 wt. % water, based on the total weight of the liquid medium. The solvents that, if present, make up less than 50 wt. % of the liquid medium include organic solvents. Non-limiting examples of suitable organic solvents include polar organic solvents, e.g. protic organic solvents such as glycols, glycol ether alcohols, alcohols, volatile ketones, glycol diethers, esters, and diesters. Other non-limiting examples of organic solvents include aromatic and aliphatic hydrocarbons.

Further, the term “self-crosslinkable” refers to a polymeric particle having two or more functional groups that are reactive with each other and which participate in intramolecular and/or intermolecular crosslinking reactions to form a covalent linkage in the absence of any external crosslinking agent. For example, the polymeric particles of the present invention can each comprise hydrazide functional groups as well as a keto and/or aldo functional groups that can react with each other to yield hydrazone linkages. As used herein, a “crosslinking agent”, “crosslinker”, and like terms refers to a molecule comprising two or more functional groups that are reactive with other functional groups and which is capable of linking two or more monomers or polymer molecules through chemical bonds. It is appreciated that the self-crosslinkable core-shell particles can also react with separate crosslinking agents when present.

### II. Multistage Self-Crosslinkable Polymeric Compositions

Provided herein are multistage self-crosslinkable polymers that comprise (i) a first stage with a first copolymer comprising diacetone acrylamide; and (ii) a second stage with a second copolymer comprising diacetone acrylamide. Diacetone moieties in the polymer backbone reacts with polyhydrazides like adipic dihydrazide to form crosslinked polymer films.

The weight ratio of the first stage copolymer to the second stage copolymer in the multistage particle may be in a range of from about 50:50 or greater, about 60:40 or greater, about 70:30 or greater, about 80:20 or greater, about 90:10 or greater, about 95:5 or greater, about 97.5:2.5 or greater, or any value encompassed by these endpoints.

The second stage copolymer may be present in the multistage particle in an amount of about 2.5 wt. % or greater, about 5 wt. % or greater, about 10 wt. % or greater, about 15 wt. % or greater, about 20 wt. % or less, about 25 wt. % or less, about 30 wt. % or less, about 35 wt. % or less, about 40 wt. % or less, or any value encompassed by these endpoints, such as about 2.5 wt. % to about 40 wt. %, about 10 wt. % to about 25 wt. %, about 5 wt. % to about 15 wt. %, or about 35 wt. % to about 40 wt. %, for example, based on the total particle weight.

In some embodiments, the first stage polymers theoretical T_{g} can be about −100° C. or greater, about −90° C. or greater, about −80° C. or greater, about −70° C. or greater, about −60° C. or greater, about −50° C. or greater, about −40° C. or greater, about −30° C. or greater, about −20° C. or less, about −10° C. or less, about 0° C. or less, about 10° C. or less, about 20° C. or less, about 30° C. or less, about 40° C. or less, about 50° C. or less, or any value encompassed by these endpoints. For example, the first stage theoretical T_{g} may be about −100° C. to about 50° C., about −90° C. to about 40° C., about −30° C. to about 20° C., or about 10° C. to about 50° C., among others.

The second stage polymers may have a theoretical T_{g} of about −50° C. or greater about −20° C. or greater, about 0° C. or greater, about 20° C. or greater, about 40° C. or greater, about 60° C. or greater, about 80° C. or greater, about 100° C. or greater, about 120° C. or less, about 140° C. or less, about 160° C. or less, about 180° C. or less, about 200° C. or less, about 220° C. or less, about 240° C. or less, about 250° C. or less, or any value encompassed by these endpoints, such as −50° C. to 250° C., 0° C. to 180° C., 10° C. to 140° C., 20° C. to 120° C., 30° C. to 120° C., 30° C. to 80° C., 10° C. to 240° C., or 30° C. to 140° C., for example.

The two stages of the polymer may comprise one or more reactive functional groups. The term “reactive functional group” refers to an atom, group of atoms, functionality, or group having sufficient reactivity to form at least one covalent bond with another co-reactive group in a chemical reaction. Examples of reactive functional groups are keto functional groups (also referred to as ketone functional groups) and/or aldo functional groups (also referred to as aldehyde functional groups) as well as hydrazide functional groups. Other non-limiting examples of additional reactive functional groups that can be present in the first or second polymer stage include carboxylic acid groups, amine groups, epoxide groups, hydroxyl groups, thiol groups, carbamate groups, carbodiimide groups, amide groups, urea groups, isocyanate groups (including blocked isocyanate groups), ethylenically unsaturated groups, alkoxy silane groups, and combinations thereof. As used herein, “ethylenically unsaturated” refers to a group having at least one carbon-carbon double bond. Non-limiting examples of ethylenically unsaturated groups include, but are not limited to, (meth)acrylate groups, vinyl groups, and combinations thereof.

In some embodiments the weight % ratio of the keto or aldehyde monomer of the first stage polymer to that of the second stage polymer may be 1:10 to 1:0.5, 1:5 to 1:0.75, 1:2.5 to 1:1, or 1:0.75 to 1:0.5 based on the total monomer weight of the respective stages.

As stated above, the film forming latex particles have a reactive functional group which constitutes the self-crosslinking moiety. After the architectural composition is applied to a substrate and the aqueous component evaporates, the reactive functional groups crosslinks with a cross-linking agent residing in the aqueous phase. A preferred self-crosslinking moiety is formed by monomers, such as diacetone acrylamide (DAAM) and suitable cross-linking agents include adipic acid dihydrazide (ADH).

Such in situ crosslinking gives improved properties over paints or architectural compositions comprising non-cross-linkable polymer. Other suitable crosslinkable monomers, such as diacetone methacrylamide (DAMAM), acetoacetoxyethyl methacrylate (AAEM) can be co-polymerized with film forming monomers to produce self-crosslinkable film forming latex particles. Suitable diacetone (meth)acrylamide monomers are represented by the formula CH₂=CR₁C(O)NR₂C(O)R₃ wherein R₁ is hydrogen or methyl; R₂ is hydrogen, a C₁-C₄ alkyl group, or a phenyl group; and R₃ is hydrogen, a C₁-C₄ alkyl group, or a phenyl group. For example, the (meth)acrylamide derivative can be diacetone acrylamide (DAAM) or diacetone methacrylamide. Polyhydrazides are used in combination with DAAM or diacetone (meth)acrylamide to form crosslinked polymers. Suitable polyhydrazides are adipic dihydrazide, phthalic dihydrazide, terephthalic dihydrazide, trimellitic trihydrazide, and others.

The amount of DAAM in the first polymer stage may be 0.5 wt. % or greater, 1 wt. % or greater, 1.5 wt. % or greater, 2 wt. % or greater, 2.5 wt. % or greater, 3 wt. % or greater, 3.5 wt. % or greater, 4 wt. % or greater, 4.5 wt. % or greater, 5 wt. % or greater, 10 wt. % or greater, or 15 wt. % or greater.

The amount of DAAM in the second polymer stage may be 0.5 wt. % or greater, 1 wt. % or greater, 1.5 wt. % or greater, 2 wt. % or greater, 2.5 wt. % or greater, 3 wt. % or greater, 3.5 wt. % or greater, 4 wt. % or greater, 4.5 wt. % or greater, 5 wt. % or greater, 10 wt. % or greater, or 15 wt. % or greater.

The total of DAAM in the polymer dispersion may be 0.5 wt. % or greater, 1 wt. % or greater, 1.5 wt. % or greater, 2 wt. % or greater, 2.5 wt. % or greater, 3 wt. % or greater, 3.5 wt. % or greater, 4 wt. % or greater, 4.5 wt. % or greater, 5 wt. % or greater, 10 wt. % or greater, 15 wt. % or greater, 20 wt. % or greater, 25 wt. % or greater, 30 wt. % or greater, 35 wt. % or greater, or 40 wt. % or greater. The weight % ratio of the aldehyde or keto monomer of the first stage polymer to the second stage polymer is 1:10 to 1:0.5 based on the total monomer weight of the respective stages.

The amount of adipic dihydrazide may be 0.1 wt. % or greater, 0.2 wt. % or greater, 0.3 wt. % or greater, 0.4 wt. % or greater, 0.5 wt. % or greater, 0.6 wt. % or greater, 0.7 wt. % or greater, 0.8 wt. % or greater, 0.9 wt. % or greater, 1 wt. % or greater, 1.5 wt. % or greater, 2 wt. % or greater, 2.5 wt. % or greater, 3 wt. % or greater, 5 wt. % or greater, or 10 wt. % or greater.

The ratio of the keto group in DAAM or diacetone (meth)acrylamide and hydrazide group in polyhydrazide varies between 1:0.4 equivalents to 1:1.5 equivalents (e.g., 1:0.5 equivalents to 1:1.5 equivalents 1:0.6 equivalents to 1:2 equivalents, 1:0.7 equivalents to 1:1 equivalents 1:0.8 equivalents to 1:1 equivalents, 1:0.9 equivalents to 1:1 equivalents). For example, the keto group to polyhydrazide group ratio may be 1:0.4, 1:0.45, 1:0.5, 1:0.55, 1:0.6, 1:0.65, 1:0.7, 1:0.75, 1:0.8, 1:0.85, 1:0.9, 1:0.95, 1:1, 1:1.05, 1:1.1, 1:1.15, 1; 1.2, 1:1.25, 1:1.3, 1:1.35, 1:1.4, 1:45, or 1:1.5.

The first stage copolymer and the second stage copolymer can also be derived from ethylenically-unsaturated monomers. Exemplary ethylenically-unsaturated monomers include (meth)acrylate monomers, vinyl aromatic monomers (e.g., styrene), ethylenically unsaturated aliphatic monomers (e.g., butadiene), vinyl ester monomers (e.g., vinyl acetate), and combinations thereof.

In some embodiments, the first stage copolymer can include an acrylic-based copolymer. Acrylic-based copolymers include copolymers derived from one or more (meth)acrylate monomers. The acrylic-based copolymer can be a pure acrylic polymer (i.e., a copolymer derived primarily from (meth)acrylate monomers), a styrene-acrylic polymer (i.e., a copolymer derived from styrene and one or more (meth)acrylate monomers), or a vinyl-acrylic polymer (i.e., a copolymer derived from one or more vinyl ester monomers and one or more (meth)acrylate monomers).

The first stage copolymer can be derived from one or more phosphorus-containing monomers. Suitable phosphorous-containing monomers are known in the art, and include dihydrogen phosphate esters of alcohols in which the alcohol contains a polymerizable vinyl or olefinic group, allyl phosphate, phosphoalkyl(meth)acrylates such as 2-phosphoethyl(meth)acrylate (PEM), 2-phosphopropyl(meth)acrylate, 3-phosphopropyl (meth)acrylate, and phosphobutyl(meth)acrylate, 3-phospho-2-hydroxypropyl(meth)acrylate, mono- or di-phosphates of bis(hydroxymethyl) fumarate or itaconate; phosphates of hydroxyalkyl(meth)acrylate, 2-hydroxyethyl(meth)acrylate, 3-hydroxypropyl(meth)acrylate, ethylene oxide condensates of (meth)acrylates, [H₂C=C(R)COO(CH₂CH₂O)ₙ]_{y}P(O)(OH)_{z}, and analogous propylene and butylene oxide condensates, where n is an integer ranging from 1 to 50, y+z=3 and y=1 or 2, z=1 or 2; R=H or CH₃ phosphoalkyl crotonates, phosphoalkyl maleates, phosphoalkyl fumarates, phosphodialkyl (meth)acrylates, phosphodialkyl crotonates, vinyl phosphonic acid, allyl phosphonic acid, 2-acrylamido-2methylpropanephosphinic acid, α-phosphonostyrene, 2-methylacrylamido-2-methylpropanephosphinic acid, (hydroxy)phosphinylalkyl(meth)acrylates, (hydroxy)phosphinylmethyl methacrylate, and combinations thereof. Phosphates of hydroxyalkyl(meth)acrylates may have the general formula [H₂C=C(R)COOCnH₂nO]_{y}P(O)(OH)_{z} where n is 2, 3 or 4; y+z=3 and y=1 or 2, z=1 or 2; R is H or CH₃. Examples of phosphate containing unsaturated monomers are Sipomer® PAM 4000, Sipomer® PAM 200, Sipomer® PAM 100, and Sipomer® PAM 600. Alkali or alkaline earth metal ion or ammonia neutralized salts of the above acids and combinations thereof can also be used.

The first stage copolymer can be derived from 0.1% to 5% by weight of one or more phosphorus-containing monomers, based on the total weight of the monomers used to form the first copolymer, such as about 0.1 wt. % or greater, about 0.2 wt. % or greater, about 0.5 wt. % or greater, about 0.7 wt. % or greater, about 1 wt. % or greater, about 2 wt. % or less, about 3 wt. % or less, about 4 wt. % or less, about 5 wt. % or less, or any value encompassed by these endpoints, such as about 0.1 wt. % to about 0.2 wt. %, about 0.3 wt. % to about 4 wt. %, or about 0.5 wt. % to about 2 wt. %, for example.

The first copolymer can be derived from an amount of one or more phosphorus-containing monomers ranging from any of the minimum percentages described above to any of the maximum percentages described above. For example, the first copolymer can be derived from 0.1% by weight to 5% by weight of one or more phosphorus-containing monomers, based on the total weight of the monomers used to form the first copolymer (e.g., from 0.1% by weight to 2.5% by weight of one or more phosphorus-containing monomers). In certain embodiments, the first copolymer is derived from 0.1% by weight to 5% by weight (e.g., 0.1% by weight to 3% by weight, 0.1% by weight to 2.5% by weight, or 0.1% by weight to 1.5% by weight) 2-phosphoethyl methacrylate and phospho di(ethyl methacrylate) of the general formula [H₂C=C(R)COOCH₂CH₂O]_{y}P(O)(OH)_{z} where y+z=3 and y=1 or 2, z=1 or 2; R=H or CH₃.

The first copolymer can be derived from an amount of one or more phosphorus-containing monomers ranging from any of the minimum percentages described above to any of the maximum percentages described above. For example, the first copolymer can be derived from greater than 0% by weight to 5% by weight of one or more phosphorus-containing monomers, based on the total weight of the monomers used to form the first copolymer (e.g., from greater than 0% by weight to 2.5% by weight of one or more phosphorus-containing monomers). In certain embodiments, the first copolymer is derived from greater than 0% by weight to 5% by weight (e.g., greater than 0% by weight to 3% by weight, greater than 0% by weight to 2.5% by weight, or greater than 0% by weight to 1.5% by weight) 2-phosphoethyl methacrylate (PEM).

The first stage copolymer can be derived from one or more additional self-crosslinking monomers. Suitable additional self-crosslinking monomers are known in the art, and include acetoacetoxyalkyl (meth)acrylates, such as acetoacetoxyethyl (meth)acrylate (AAEM), acetoacetoxypropyl (meth)acrylate, acetoacetoxybutyl (meth)acrylate, and 2,3-di(acetoacetoxy)propyl (meth)acrylate; allyl acetoacetate; vinyl acetoacetate; and combinations thereof.

The first stage copolymer can be derived from one or more carboxylic acid-containing monomers based on the total weight of monomers. Suitable carboxylic acid-containing monomers are known in the art, and include α,β-monoethylenically unsaturated mono- and dicarboxylic acids, such as acrylic acid, methacrylic acid, itaconic acid, crotonic acid, maleic acid, fumaric acid, dimethacrylic acid, ethylacrylic acid, allylacetic acid, vinylacetic acid, mesaconic acid, methylenemalonic acid, citraconic acid, and combinations thereof.

The first stage copolymer can be derived from one or more acrylate or methacrylate monomers. Exemplary acrylate and methacrylate monomers include, but are not limited to, methyl acrylate, methyl methacrylate, ethyl acrylate, ethyl methacrylate, butyl acrylate, butyl methacrylate, 2-ethylhexyl acrylate, 2-ethylhexyl methacrylate, isobutyl (meth)acrylate, n-hexyl (meth)acrylate, n-heptyl (meth)acrylate, 2-methylheptyl (meth)acrylate, octyl (meth)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, lauryl (meth)acrylate, tridecyl (meth)acrylate, stearyl (meth)acrylate, glycidyl (meth)acrylate, alkyl crotonates, vinyl acetate, di-n-butyl maleate, di-octylmaleate, hydroxyethyl (meth)acrylate, allyl (meth)acrylate, tetrahydrofurfuryl (meth)acrylate, cyclohexyl (meth)acrylate, 2-ethoxyethyl (meth)acrylate, 2-methoxy (meth)acrylate, 2-(2-ethoxyethoxy)ethyl (meth)acrylate, 2-propylheptyl (meth)acrylate, 2-phenoxyethyl (meth)acrylate, isobornyl (meth)acrylate, caprolactone (meth)acrylate, polypropyleneglycol mono(meth)acrylate, polyethyleneglycol (meth)acrylate, benzyl (meth)acrylate, hydroxypropyl (meth)acrylate, methylpolyglycol (meth)acrylate, 3,4-epoxycyclohexylmethyl (meth)acrylate, 1,6 hexanediol di(meth)acrylate, 1,4 butanediol di(meth)acrylate, and combinations thereof. In some embodiments, the first copolymer is derived from one or more (meth)acrylate monomers selected from the group consisting of methyl methacrylate, n-butyl acrylate, 2-ethylhexylacrylate, and combinations thereof. In some embodiments, the first copolymer is derived from methyl methacrylate and butyl acrylate.

The first copolymer can be derived from one or more vinyl aromatic compounds. Suitable vinyl aromatic compounds include styrene, α- and p-methylstyrene, α-butylstyrene, 4-n-butylstyrene, 4-n-decylstyrene, vinyltoluene, and combinations thereof. Vinyl esters of carboxylic acids having comprising up to 20 carbon atoms include, for example, vinyl laurate, vinyl stearate, vinyl propionate, versatic acid vinyl esters, vinyl acetate, and combinations thereof. The vinyl halides can include ethylenically unsaturated compounds substituted by chlorine, fluorine or bromine, such as vinyl chloride and vinylidene chloride. The vinyl ethers can include, for example, vinyl ethers of alcohols comprising 1 to 4 carbon atoms, such as vinyl methyl ether or vinyl isobutyl ether. Aliphatic hydrocarbons having 2 to 8 carbon atoms and one or two double bonds can include, for example, hydrocarbons having 4 to 8 carbon atoms and two olefinic double bonds, such as butadiene, isoprene, and chloroprene. Silane containing monomers can include, for example, vinyl silanes, such as vinyltrimethoxysilane, vinyltriethoxysilane (VTEO), vinyl tris(2-methoxyethoxysilane), and vinyl triisopropoxysilane, and (meth)acrylatoalkoxysilanes, such as (meth)acryloyloxypropyltrimethoxysilane, γ-(meth)acryloxypropyltrimethoxysilane, and γ-(meth)acryloxypropyltriethoxysilane.

In some embodiments, monomers for the first stage copolymer include wet adhesion promoting monomers such ureido (cyclic ethylene urea) functional monomers and diketo functional monomers. Specific examples include ureido methacrylate (UMA) and acetoacetoxy ethyl methacrylate.

The second stage polymer can be a homopolymer derived from a single ethylenically-unsaturated monomer or a copolymer derived from ethylenically-unsaturated monomers. In some embodiments, the second stage polymer includes an acrylic-based polymer. Acrylic-based polymers include polymers derived from one or more (meth)acrylate monomers. The acrylic-based polymer can be a pure acrylic polymer (i.e., a polymer derived exclusively from (meth)acrylate monomers), a styrene-acrylic polymer (i.e., a copolymer derived from styrene and one or more (meth)acrylate monomers), or a vinyl-acrylic polymer (i.e., a copolymer derived from one or more vinyl ester monomers and one or more (meth)acrylate monomers).

The second stage copolymer can also be derived from ethylenically-unsaturated monomers. Exemplary ethylenically-unsaturated monomers include (meth)acrylate monomers, vinyl aromatic monomers (e.g., styrene), ethylenically unsaturated aliphatic monomers (e.g., butadiene), vinyl ester monomers (e.g., vinyl acetate), and combinations thereof.

In some embodiments, the second stage copolymer can include an acrylic-based copolymer. Acrylic-based copolymers include copolymers derived from one or more (meth)acrylate monomers. The acrylic-based copolymer can be a pure acrylic polymer (i.e., a copolymer derived primarily from (meth)acrylate monomers), a styrene-acrylic polymer (i.e., a copolymer derived from styrene and one or more (meth)acrylate monomers), or a vinyl-acrylic polymer (i.e., a copolymer derived from one or more vinyl ester monomers and one or more (meth)acrylate monomers).

The second stage copolymer can be derived from one or more phosphorus-containing monomers. Suitable phosphorous-containing monomers are known in the art, and include dihydrogen phosphate esters of alcohols in which the alcohol contains a polymerizable vinyl or olefinic group, allyl phosphate, phosphoalkyl(meth)acrylates such as 2-phosphoethyl(meth)acrylate (PEM), 2-phosphopropyl(meth)acrylate, 3-phosphopropyl (meth)acrylate, and phosphobutyl(meth)acrylate, 3-phospho-2-hydroxypropyl(meth)acrylate, mono- or di-phosphates of bis(hydroxymethyl) fumarate or itaconate; phosphates of hydroxyalkyl(meth)acrylate, 2-hydroxyethyl(meth)acrylate, 3-hydroxypropyl(meth)acrylate, ethylene oxide condensates of (meth)acrylates, [H₂C=C(R)COO(CH₂CH₂O)ₙ]_{y}P(O)(OH)_{z}, and analogous propylene and butylene oxide condensates, where n is an integer ranging from 1 to 50, y+z=3 and y=1 or 2, z=1 or 2; R=H or CH₃ phosphoalkyl crotonates, phosphoalkyl maleates, phosphoalkyl fumarates, phosphodialkyl (meth)acrylates, phosphodialkyl crotonates, vinyl phosphonic acid, allyl phosphonic acid, 2-acrylamido-2methylpropanephosphinic acid, α-phosphonostyrene, 2-methylacrylamido-2-methylpropanephosphinic acid, (hydroxy)phosphinylalkyl(meth)acrylates, (hydroxy)phosphinylmethyl methacrylate, and combinations thereof. Phosphates of hydroxyalkyl(meth)acrylates may have the general formula [H₂C=C(R)COOCₙH₂nO]_{y}P(O)(OH)_{z} where n is 2, 3 or 4; y+z=3 and y=1 or 2, z=1 or 2; R is H or CH₃. Examples of phosphate containing unsaturated monomers are Sipomer® PAM 4000, Sipomer® PAM 200, Sipomer® PAM 100, and Sipomer® PAM 600. Alkali or alkaline earth metal ion or ammonia neutralized salts of the above acids and combinations thereof can also be used.

The second stage copolymer can optionally be derived from 0.0% to 5% by weight of one or more phosphorus-containing monomers, based on the total weight of the monomers used to form the second stage copolymer, such as about 0.1 wt. % or greater, about 0.2 wt. % or greater, about 0.5 wt. % or greater, about 0.7 wt. % or greater, about 1 wt. % or greater, about 2 wt. % or less, about 3 wt. % or less, about 4 wt. % or less, about 5 wt. % or less, or any value encompassed by these endpoints, such as about 0.0 wt. % to about 0.2 wt. %, about 0.3 wt. % to about 4 wt. %, or about 0.5 wt. % to about 2 wt. %, for example.

The second stage copolymer can be derived from an amount of one or more phosphorus-containing monomers ranging from any of the minimum percentages described above to any of the maximum percentages described above. For example, the second stage copolymer can be derived from 0.0% by weight to 5% by weight of one or more phosphorus-containing monomers, based on the total weight of the monomers used to form the second stage copolymer (e.g., from 0.0% by weight to 2.5% by weight of one or more phosphorus-containing monomers). In certain embodiments, the second stage copolymer is derived from 0.1% by weight to 5% by weight (e.g., 0.1% by weight to 3% by weight, 0.1% by weight to 2.5% by weight, or 0.1% by weight to 1.5% by weight) 2-phosphoethyl methacrylate and phospho di(ethyl methacrylate) of the general formula [H₂C=C(R)COOCH₂CH₂O]_{y}P(O)(OH)_{z} where y+z=3 and y=1 or 2, z=1 or 2; R=H or CH₃.

The second stage copolymer can be derived from an amount of one or more phosphorus-containing monomers ranging from any of the minimum percentages described above to any of the maximum percentages described above. For example, the second copolymer can be derived from greater than 0% by weight to 5% by weight of one or more phosphorus-containing monomers, based on the total weight of the monomers used to form the second copolymer (e.g., from greater than 0% by weight to 2.5% by weight of one or more phosphorus-containing monomers). In certain embodiments, the second copolymer is derived from greater than 0% by weight to 5% by weight (e.g., greater than 0% by weight to 3% by weight, greater than 0% by weight to 2.5% by weight, or greater than 0% by weight to 1.5% by weight) 2-phosphoethyl methacrylate (PEM).

The second stage copolymer can be derived from one or more self-crosslinking monomers. Suitable self-crosslinking monomers are known in the art, and include acetoacetoxyalkyl (meth)acrylates, such as acetoacetoxyethyl (meth)acrylate (AAEM), acetoacetoxypropyl (meth)acrylate, acetoacetoxybutyl (meth)acrylate, and 2,3-di(acetoacetoxy)propyl (meth)acrylate; allyl acetoacetate; vinyl acetoacetate; and combinations thereof.

The second stage copolymer can be derived from one or more carboxylic acid-containing monomers based on the total weight of monomers. Suitable carboxylic acid-containing monomers are known in the art, and include α,β-monoethylenically unsaturated mono- and dicarboxylic acids, such as acrylic acid, methacrylic acid, itaconic acid, crotonic acid, maleic acid, fumaric acid, dimethacrylic acid, ethylacrylic acid, allylacetic acid, vinylacetic acid, mesaconic acid, methylenemalonic acid, citraconic acid, and combinations thereof.

The second stage copolymer can be derived from one or more acrylate or methacrylate monomers. Exemplary acrylate and methacrylate monomers include, but are not limited to, methyl acrylate, methyl methacrylate, ethyl acrylate, ethyl methacrylate, butyl acrylate, butyl methacrylate, 2-ethylhexyl acrylate, 2-ethylhexyl methacrylate, isobutyl (meth)acrylate, n-hexyl (meth)acrylate, n-heptyl (meth)acrylate, 2-methylheptyl (meth)acrylate, octyl (meth)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, lauryl (meth)acrylate, tridecyl (meth)acrylate, stearyl (meth)acrylate, glycidyl (meth)acrylate, alkyl crotonates, vinyl acetate, di-n-butyl maleate, di-octylmaleate, hydroxyethyl (meth)acrylate, allyl (meth)acrylate, tetrahydrofurfuryl (meth)acrylate, cyclohexyl (meth)acrylate, 2-ethoxyethyl (meth)acrylate, 2-methoxy (meth)acrylate, 2-(2-ethoxyethoxy)ethyl (meth)acrylate, 2-propylheptyl (meth)acrylate, 2-phenoxyethyl (meth)acrylate, isobornyl (meth)acrylate, caprolactone (meth)acrylate, polypropyleneglycol mono(meth)acrylate, polyethyleneglycol (meth)acrylate, benzyl (meth)acrylate, hydroxypropyl (meth)acrylate, methylpolyglycol (meth)acrylate, 3,4-epoxy cy clohexylmethyl (meth)acrylate, 1,6 hexanediol di(meth)acrylate, 1,4 butanediol di(meth)acrylate, and combinations thereof. In some embodiments, the second copolymer is derived from one or more (meth)acrylate monomers selected from the group consisting of methyl methacrylate, n-butyl acrylate, 2-ethylhexylacrylate, and combinations thereof. In some embodiments, the second copolymer is derived from methyl methacrylate and butyl acrylate.

The second copolymer can be derived from one or more vinyl aromatic compounds. Suitable vinyl aromatic compounds include styrene, α- and p-methylstyrene, α-butylstyrene, 4-n-butylstyrene, 4-n-decylstyrene, vinyltoluene, and combinations thereof. Vinyl esters of carboxylic acids having comprising up to 20 carbon atoms include, for example, vinyl laurate, vinyl stearate, vinyl propionate, versatic acid vinyl esters, vinyl acetate, and combinations thereof. The vinyl halides can include ethylenically unsaturated compounds substituted by chlorine, fluorine or bromine, such as vinyl chloride and vinylidene chloride. The vinyl ethers can include, for example, vinyl ethers of alcohols comprising 1 to 4 carbon atoms, such as vinyl methyl ether or vinyl isobutyl ether. Aliphatic hydrocarbons having 2 to 8 carbon atoms and one or two double bonds can include, for example, hydrocarbons having 4 to 8 carbon atoms and two olefinic double bonds, such as butadiene, isoprene, and chloroprene. Silane containing monomers can include, for example, vinyl silanes, such as vinyltrimethoxysilane, vinyltriethoxysilane (VTEO), vinyl tris(2-methoxyethoxysilane), and vinyl triisopropoxysilane, and (meth)acrylatoalkoxysilanes, such as (meth)acryloyloxypropyltrimethoxysilane, γ-(meth)acryloxypropyltrimethoxysilane, and γ-(meth)acryloxypropyltriethoxysilane.

In some embodiments, monomers for the second stage copolymer include wet adhesion promoting monomers such ureido (cyclic ethylene urea) functional monomers and diketo functional monomers. Specific examples include ureido methacrylate (UMA) and acetoacetoxy ethyl methacrylate.

Also provided are aqueous compositions comprising one or more of the multistage self-crosslinking polymers described above. The aqueous compositions can further include one or more additives, including pigments, fillers, dispersants, coalescents, pH modifying agents, plasticizers, defoamers, surfactants, thickeners, biocides, co-solvents, and combinations thereof. The choice of additives in the composition will be influenced by a number of factors, including the nature of the multistage polymers (or multilayer particles) dispersed in the aqueous composition, as well as the intended use of the composition. In some cases, the composition can be, for example, a coating composition, such as a paint, a primer, or a paint-and-primer-in-one formulation.

Examples of suitable pigments include metal oxides, such as titanium dioxide, zinc oxide, iron oxide, or combinations thereof. In certain embodiments, the composition includes a titanium dioxide pigment. Examples of commercially titanium dioxide pigments are KRONOS® 2101, KRONOS® 2310, available from Kronos WorldWide, Inc. (Cranbury, N.J.), TI-PURE® R-900, available from DuPont (Wilmington, Del.), or TIONA® ATl commercially available from Millenium Inorganic Chemicals. Titanium dioxide is also available in concentrated dispersion form. An example of a titanium dioxide dispersion is KRONOS® 4311, also available from Kronos WorldWide, Inc.

Examples of suitable fillers include calcium carbonate, nepheline syenite, (25% nepheline, 55% sodium feldspar, and 20% potassium feldspar), feldspar (an aluminosilicate), diatomaceous earth, calcined diatomaceous earth, talc (hydrated magnesium silicate), aluminosilicates, silica (silicon dioxide), alumina (aluminum oxide), clay, (hydrated aluminum silicate), kaolin (kaolinite, hydrated aluminum silicate), mica (hydrous aluminum potassium silicate), pyrophyllite (aluminum silicate hydroxide), perlite, baryte (barium sulfate), Wollastonite (calcium metasilicate), and combinations thereof. In certain embodiments, the composition comprises a calcium carbonate filler.

Examples of suitable dispersants are polyacid dispersants and hydrophobic copolymer dispersants. Polyacid dispersants are typically polycarboxylic acids, such as polyacrylic acid or polymethacrylic acid, which are partially or completely in the form of their ammonium, alkali metal, alkaline earth metal, ammonium, or lower alkyl quaternary ammonium salts. Hydrophobic copolymer dispersants include copolymers of acrylic acid, methacrylic acid, or maleic acid with hydrophobic monomers. In certain embodiments, the composition includes a polyacrylic acid-type dispersing agent, such as Dispex CX 4230, commercially available from BASF SE.

Suitable coalescents, which aid in film formation during drying, include ethylene glycol monomethyl ether, ethylene glycol monobutyl ether, ethylene glycol monoethyl ether acetate, ethylene glycol monobutyl ether acetate, diethylene glycol monobutyl ether, diethylene glycol monoethyl ether acetate, dipropylene glycol monomethyl ether, 2,2,4-trimethyl-1,3-pentanediol monoisobutyrate,2-ethylhexyl benzoate, and combinations thereof. Suitable coalescing agents also include Loxanol® series of low VOC coalescing agents available from BASF Inc.

Examples of suitable thickening agents include hydrophobically modified ethylene oxide urethane (HEUR) polymers, hydrophobically modified alkali soluble emulsion (HASE) polymers, hydrophobically modified hydroxyethyl celluloses (HMHECs), hydrophobically modified polyacrylamide, and combinations thereof. HEUR polymers are linear reaction products of diisocyanates with polyethylene oxide end-capped with hydrophobic hydrocarbon groups. HASE polymers are homopolymers of (meth)acrylic acid, or copolymers of (meth)acrylic acid, (meth)acrylate esters, or maleic acid modified with hydrophobic vinyl monomers. HMHECs include hydroxyethyl cellulose modified with hydrophobic alkyl chains. Hydrophobically modified polyacrylamides include copolymers of acrylamide with acrylamide modified with hydrophobic alkyl chains (N-alkyl acrylamide). In certain embodiments, the coating composition includes a hydrophobically modified hydroxyethyl cellulose thickener.

Examples of suitable pH modifying agents include amino alcohols, monoethanolamine (MEA), diethanolamine (DEA), 2-(2-aminoethoxy)ethanol, diisopropanolamine (DIPA), 1-amino-2-propanol (AMP), ammonia, and combinations thereof.

Defoamers serve to minimize frothing during mixing and/or application of the coating composition. Suitable defoamers include silicone oil defoamers, such as polysiloxanes, polydimethylsiloxanes, polyether modified polysiloxanes, mineral oil defoamers, hyperbranched polymers and combinations thereof. Exemplary defoamers include the Foamaster® and EFKA series of defoamers available from BASF Inc., the BYK® series of defoamers available from BYK USA Inc. (Wallingford, Conn.), the TEGO® series of defoamers, available from Evonik Industries (Hopewell, Va.), and the DREWPLUS® series of defoamers, available from Ashland Inc. (Covington, Ky.).

Suitable surfactants include nonionic surfactants and anionic surfactants. Examples of nonionic surfactants are alkylphenoxy polyethoxyethanols having alkyl groups of about 7 to about 18 carbon atoms and having from about 6 to about 60 oxyethylene units; ethylene oxide derivatives of long chain carboxylic acids; analogous ethylene oxide condensates of long chain alcohols, and combinations thereof. Exemplary anionic surfactants include ammonium, alkali metal, alkaline earth metal, and lower alkyl quaternary ammonium salts of sulfosuccinates, higher fatty alcohol sulfates, aryl sulfonates, alkyl sulfonates, alkylaryl sulfonates, and combinations thereof. In certain embodiments, the composition comprises a nonionic alkylpolyethylene glycol surfactant, such as Hydropalat WE 3320, LUTENSOL® TDA 8 or LUTENSOL® AT-18, commercially available from BASF SE. In certain embodiments, the composition comprises an anionic alkyl ether sulfate surfactant, such as DISPONIL® FES 77, commercially available from BASF SE. In certain embodiments, the composition comprises an anionic diphenyl oxide disulfonate surfactant, such as CALFAX® DB-45, commercially available from Pilot Chemical. In some embodiments, the composition is substantially free (i.e., the composition includes 0.1% or less by weight) of sulfate surfactants. In some embodiments, the composition is substantially free (i.e., the composition includes 0.1% or less by weight) of sulfonate surfactants. In some embodiments, the composition is substantially free (i.e., the composition includes 0.1% or less by weight) of sulfate surfactants and sulfonate surfactants.

Suitable biocides can be incorporated to inhibit the growth of bacteria and other microbes in the coating composition during storage. Exemplary biocides include 2-[(hydroxymethyl)amino]ethanol, 2-[(hydroxymethyl) amino]2-methyl-1-propanol, o-phenylphenol, sodium salt, 1,2-benzisothiazolin-3-one, 2-methyl-4-isothiazolin-3-one (MIT), 5-chloro2-methyland-4-isothiazolin-3-one (CIT), 2-octyl-4-isothiazolin-3-one (OTT), 4,5-dichloro-2-n-octyl-3-isothiazolone, as well as acceptable salts and combinations thereof. Suitable biocides also include mildewcides that inhibit the growth mildew or its spores in the coating. Examples of mildewcides include 2-(thiocyanomethylthio)benzothiazole, 3-iodo-2-propynyl butyl carbamate, 2,4,5,6-tetrachloroisophthalonitrile, 2-(4-thiazolyl)benzimidazole, 2-N-octyl4-isothiazolin-3-one, diiodomethyl p-tolyl sulfone, as well as acceptable salts and combinations thereof. In certain embodiments, the coating composition contains 1,2-benzisothiazolin-3-one or a salt thereof. Biocides of this type include PROXEL® BD20, commercially available from Arch Chemicals, Inc (Atlanta, Ga.).

Exemplary co-solvents and plasticizers include ethylene glycol, propylene glycol, diethylene glycol, and combinations thereof.

Other suitable additives that can optionally be incorporated into the composition include rheology modifiers, wetting and spreading agents, leveling agents, conductivity additives, adhesion promoters, anti-blocking agents, anti-cratering agents and anti-crawling agents, anti-freezing agents, corrosion inhibitors, anti-static agents, flame retardants and intumescent additives, dyes, optical brighteners and fluorescent additives, UV absorbers and light stabilizers, chelating agents, cleanability additives, crosslinking agents, flatting agents, flocculants, humectants, insecticides, lubricants, odorants, oils, waxes and slip aids, soil repellants, stain resisting agents, and combinations thereof.

Coating compositions can be applied to a surface by any suitable coating technique, including spraying, rolling, brushing, or spreading. Coating compositions can be applied in a single coat, or in multiple sequential coats (e.g., in two coats or in three coats) as required for a particular application. Generally, the coating composition is allowed to dry under ambient conditions. However, in certain embodiments, the coating composition can be dried, for example, by heating and/or by circulating air over the coating.

The coating compositions can be applied to a variety of surfaces including, but not limited to metal, asphalt, concrete, stone, ceramic, wood, plastic, polyurethane foam, glass, wall board coverings (e.g., drywall, cement board, etc.), and combinations thereof. The coating compositions can be applied to interior or exterior surfaces. In certain embodiments, the surface is an architectural surface, such as a roof, wall, floor, or combination thereof. The architectural surface can be located above ground, below ground, or combinations thereof.

Also provided are coatings formed from the coating compositions described herein. Generally, coatings are formed by applying a coating composition described herein to a surface and allowing the coating to dry to form a coating. The coating thickness can vary depending upon the application of the coating.

Also provided are methods of making the multistage polymers and multilayer particles described above. The multistage polymers and multilayer particles described above can be prepared by heterophase polymerization techniques, including, for example, free-radical emulsion polymerization, suspension polymerization, and mini-emulsion polymerization. In some examples, the multistage polymer is prepared by polymerizing the monomers using free-radical emulsion polymerization. The emulsion polymerization temperature can range from 10° C. to 130° C. (e.g., from 50° C. to 90° C.). The polymerization medium can include water alone or a mixture of water and water-miscible liquids, such as methanol, ethanol or tetrahydrofuran. In some embodiments, the polymerization medium is free of organic solvents and includes only water.

The emulsion polymerization can be carried out as a batch process, as a semi-batch process, or in the form of a continuous process. In some embodiments, a portion of the monomers can be heated to the polymerization temperature and partially polymerized, and the remainder of the monomer batch can be subsequently fed to the polymerization zone continuously, in steps, or with superposition of a concentration gradient.

The emulsion polymerization can be performed with a variety of auxiliaries, including water-soluble initiators and regulators. Examples of water-soluble initiators for the emulsion polymerization are ammonium salts and alkali metal salts of peroxodisulfuric acid, e.g., sodium peroxodisulfate, hydrogen peroxide or organic peroxides, e.g., tert-butyl hydroperoxide. Reduction-oxidation (redox) initiator systems are also suitable as initiators for the emulsion polymerization. The redox initiator systems are composed of at least one, usually inorganic, reducing agent and one organic or inorganic oxidizing agent. The oxidizing component comprises, for example, the initiators already specified above for the emulsion polymerization. The reducing components are, for example, alkali metal salts of sulfurous acid, such as sodium sulfite, sodium hydrogen sulfite, alkali metal salts of disulfurous acid such as sodium disulfite, bisulfite addition compounds with aliphatic aldehydes and ketones, such as acetone bisulfite, or reducing agents such as hydroxymethanesulfinic acid and salts thereof, or ascorbic acid. The redox initiator systems can be used in the company of soluble metal compounds whose metallic component is able to exist in a plurality of valence states. Typical redox initiator systems include, for example, ascorbic acid/iron(II) sulfate/sodium peroxodisulfate, tert-butyl hydroperoxide/sodium disulfite, tert-butyl hydroperoxide/Na hydroxymethanesulfinate, or tert-butyl hydroperoxide/ascorbic acid. The individual components, the reducing component for example, can also be mixtures, an example being a mixture of the sodium salt of hydroxymethanesulfinic acid with sodium disulfite. The stated compounds are used usually in the form of aqueous solutions, with the lower concentration being determined by the amount of water that is acceptable in the dispersion, and the upper concentration by the solubility of the respective compound in water. The concentration can be 0.1% to 30%, 0.5% to 20%, or 1.0% to 10%, by weight, based on the solution. The amount of the initiators is generally 0.1% to 10% or 0.2% to 5% by weight, based on the monomers to be polymerized. It is also possible for two or more different initiators to be used in the emulsion polymerization. For the removal of the residual monomers, an initiator can be added after the end of the emulsion polymerization.

In the polymerization it is possible to use molecular weight regulators or chain transfer agents, in amounts, for example, of 0 to 0.8 parts by weight, based on 100 parts by weight of the monomers to be polymerized, to reduce the molecular weight of the copolymer. Suitable examples include compounds having a thiol group such as tert-butyl mercaptan, thioglycolic acid ethylacrylic esters, mercaptoethanol, mercaptopropyltrimethoxysilane, and tert-dodecyl mercaptan. Additionally, it is possible to use regulators without a thiol group, such as terpinolene. In some embodiments, the emulsion polymer is prepared in the presence of greater than 0% to 0.5% by weight, based on the monomer amount, of at least one molecular weight regulator. In some embodiments, the emulsion polymer is prepared in the presence of less than less than 0.3% or less than 0.2% by weight (e.g., 0.10% to 0.15% by weight) of the molecular weight regulator.

Dispersants, such as surfactants, can also be added during polymerization to help maintain the dispersion of the monomers in the aqueous medium. For example, the polymerization can include less than 3% by weight or less than 1% by weight of surfactants. In some embodiments, the polymerization is substantially free of surfactants and can include less than 0.05% or less than 0.01% by weight of one or more surfactants. In other embodiments, the first emulsion polymerization step and/or the second polymerization step further comprise an aryl or alkyl phosphate surfactant. These phosphate surfactants may include aloxylated alkyl or aryl surfactants. (e.g., a tristyrylphenol alkoxylated phosphate surfactant).

Anionic and nonionic surfactants can be used during polymerization. Suitable surfactants include ethoxylated C₈ to C₃₆ or C₁₂ to C₁₈ fatty alcohols having a degree of ethoxylation of 3 to 50 or of 4 to 30, ethoxylated mono-, di-, and tri-C₄ to C₁₂ or C₄ to C₉ alkylphenols having a degree of ethoxylation of 3 to 50, alkali metal salts of dialkyl esters of sulfosuccinic acid, alkali metal salts and ammonium salts of C₈ to C₁₂ alkyl sulfates, alkali metal salts and ammonium salts of C₁₂ to C₁₈ alkylsulfonic acids, and alkali metal salts and ammonium salts of C₉ to C₁₈ alkylarylsulfonic acids.

By way of non-limiting illustration, examples of certain embodiments of the present disclosure are given below.

### Examples

The following examples are put forth so as to provide those of ordinary skill in the art with a complete disclosure and description of how the compositions and/or methods claimed herein are made and evaluated and are intended to be purely exemplary and are not intended to limit the scope of the disclosure. Unless indicated otherwise, parts are parts by weight, temperature is in ° C. or is at ambient temperature, and pressure is at or near atmospheric.

### Examples 1-4: Preparation of Self-Crosslinking Polymer Latex

A polymerization vessel equipped with metering devices and temperature regulation was charged under a nitrogen atmosphere at 20° to 25° C. (room temperature) with initial charge. This initial charge was heated to 85° C. with stirring. When set temperature was reached, 7% of Feed 1 was added and the mixture was stirred for 5 minutes. Thereafter feeds 1 and 2 were commenced; feed 1 was metered in over 3.3 hours, and feed 2 over 2.55 hours. Ten minutes after the end of feed 2, feed 3 was added over 30 minutes. Ten minutes after the end of feeds, temperature was reduced to 80° C. and feed 4 was added over 15 minutes and then feed 5 was added. Then feed 6 and feed 7 were metered in over 60 minutes in parallel. After 12 minutes from the end of these feeds, the batch was cooled below 40° C. Then feed 8 was added over 5 minutes and there after feed 9 was added over 10 minutes. The batch was mixed for 5 minutes, pH adjusted 8.5 using 19% aqueous ammonium hydroxide and filtered. 00 Weight solids, pH, viscosity and particle size were measured.

Representative examples of polymer dispersions prepared using procedure 1 are provided in Table 1 below.

TABLE 1
Polymer Dispersions Prepared Using Procedure 1: Examples 1-4.

| | | Exam- | Exam- | Exam- | Exam- |
|---|---|---|---|---|---|
| | | ple 1 | ple 2 | ple 3 | ple 4 |
| | | (017) | (018) | (019) | (021) |
| | Ingredients | (grams) | (grams) | (grams) | (grams) |
| Initial | Water | 441.6 | 442.3 | 417.3 | 441.3 |
| Charge | PolyStyrene seed | 53.9 | 53.8 | 53.8 | 53.9 |
| | (32% in water) | | | | |
| Feed 1 | Water | 28.9 | 29.0 | 28.9 | 28.9 |
| | Sodium Persulfate | 1.9 | 1.9 | 1.9 | 1.9 |
| Feed 2 | Water | 180 | 191.6 | 202.1 | 202.5 |
| | TSPAP surfactant* | 33.1 | 35.2 | 37.2 | 37.3 |
| | Hydropalat WE 3320 | 4.6 | 4.9 | 5.2 | 5.2 |
| | Itaconic acid | 4.2 | 4.4 | 4.7 | 4.7 |
| | Sipomer PAM 4000 | 8.3 | 8.9 | 9.4 | 9.4 |
| | n-Butyl acrylate | 310.1 | 330 | 348.2 | 348.8 |
| | Methyl methacrylate | 395.3 | 422.4 | 447.3 | 424.4 |
| | Trimethylolpropane | 1.7 | 1.8 | 1.9 | 1.9 |
| | triacrylate | | | | |
| | Tertiary dodecyl | 0.8 | 0.8 | 0.8 | 0.8 |
| | mercaptan | | | | |
| | Vinyltriethoxy silane | 0.0 | 0.0 | 0.0 | 4.7 |
| | Diacetone | 25.0 | 26.6 | 28.0 | 46.9 |
| | Acrylamide | | | | |
| | 19% Aqueous | 4.4 | 4.7 | 4.9 | 4.9 |
| | ammonium | | | | |
| | hydroxide | | | | |
| Feed 3 | Water | 45.8 | 34.4 | 22.9 | 22.9 |
| | TSPAP surfactant* | 14.2 | 10.6 | 7.1 | 7.1 |
| | Methyl acrylate | 131.3 | 98.6 | 56.2 | 65.6 |
| | Methyl methacrylate | 43.1 | 32.4 | 21.5 | 21.3 |
| | Diacetone acrylamide | 18.7 | 14.1 | 18.7 | 4.7 |
| | Vinyltriethoxy silane | 0.0 | 0.0 | 0.0 | 0.5 |
| Feed 4 | Water | 62.0 | 62.2 | 62.0 | 62.2 |
| | 19% aqueous | 5.9 | 5.9 | 5.9 | 5.9 |
| | Ammonium | | | | |
| | hydroxide | | | | |
| Feed 5 | Rhodaline 635 | 0.9 | 0.9 | 0.9 | 0.9 |
| Feed 6 | Water | 14.7 | 14.7 | 14.7 | 1.7 |
| | Aqueous t-butyl | 0.8 | 0.8 | 0.8 | 0.8 |
| | hydroperoxide (70%) | | | | |
| Feed 7 | Water | 14.6 | 14.6 | 14.7 | 14.7 |
| | Sodium metabisulfite | 0.9 | 0.9 | 0.9 | 0.9 |
| Feed 8 | Water (at 60° C.) | 84.4 | 84.5 | 112.3 | 84.4 |
| | Adipic dihydrazide | 20.9 | 18.8 | 22.5 | 23.7 |
| Feed 9 | Water | 24.4 | 24.2 | 24.1 | 24.1 |
| | 19% aqueous | 4.9 | 4.9 | 4.9 | 4.9 |
| | ammonium | | | | |
| | hydroxide | | | | |
| % solids | | 48.5 | 48.4 | 49.3 | 48.5 |
| pH | | 8.5 | 8.7 | 8.5 | 8.5 |
| Viscosity, | | 183 | 776 | 195 | 232 |
| #2 LV | | | | | |
| spindle, | | | | | |
| 50 rpm, | | | | | |
| cPS | | | | | |
| Volume | | 112 | 109 | 105 | 103 |
| average | | | | | |
| Particle | | | | | |
| size (nm) | | | | | |

*TSPAP—Ammonium salt of Tristyrylphenol alkoxylated phosphate surfactant (24% in water)

### Comparative Example 1: Preparation of Control Polymer Latex

A multistage polymer latex comprising a first stage having a theoretical Tg of 12° C. derived from butyl acrylate, methyl methacrylate, itaconic acid, acetoacetoxyethyl methacrylate (AAEM), and 2-phosphoethyl methacrylate (PEM) and a second stage with a theoretical Tg of 100° C. derived from methyl methacrylate (“polymer 1”) was prepared by sequential emulsion polymerization steps as described below. A 3 L glass vessel was heated to 85° C. with 435 g of deionized water and 46 g of pre-polymerized seed latex. An initiator (sodium persulfate) was fed to the vessel over the course of the polymerization of both Stage 1 and Stage 2 for 3.8 hours. 1149 g of first stage emulsion comprising the monomer mixture above, an aryl phosphate surfactant, and a non-ionic surfactant was fed to the vessel over 2.5 hours. Subsequently, 212 g of second stage emulsion comprising the monomer mixture above and an aryl phosphate surfactant was fed to the vessel. After Stage 2 was completely fed, the reaction was held at temperature for 30 minutes while ammonium hydroxide and a defoamer were added. Next, the reaction temperature was decreased to 80° C., and tert-butyl hydroperoxide and sodium metabisulfite were simultaneously fed into the reaction over one hour. The reaction was then cooled to 40° C., and the pH adjusted with ammonium hydroxide. A biocide was then added to the reaction mixture. The final latex was filtered through 150 mesh. Polymer 1 exhibited a Tg of 17° C., determined by DSC using the method described in ASTM D 3418-12e1 entitled “Standard Test Method for Transition Temperatures and Enthalpies of Fusion and Crystallization of Polymers by Differential Scanning calorimetry,” which is incorporated herein by reference in its entirety.

Polymer 1 was subsequently formulated into a standard semigloss white base formulation in Table 2.

### Semigloss Paint Formulations Using Polymers of Examples 1-4 and Comparative Example 1

Semigloss paints were formulated using the polymers of the present disclosure (Examples 1-4 and Comparative Example 1 described above). The paints further comprised the components shown below in Table 2.

TABLE 2
Paint Formulation Mass Balance

| Ingredients | Grams |
|---|---|
| Water | 201.4 |
| Kronos 4311 | 280.0 |
| Dispex CX 4230 | 6.0 |
| Hydropalat WE 3320 | 3.0 |
| FoamStar ST 2434 | 5.0 |
| AMP 95 | 1.8 |
| Minex 10 | 10.0 |
| Attagel 50 | 2.0 |
| AQAcell Hide 6299 | 15.0 |
| Rheovis PE 1331 | 37.0 |
| Polyphase 678 | 3.5 |
| Proxel BD 20 | 2.0 |
| Acrysol RM8W | 6.8 |
| Velate 368 | 16.0 |
| Loxanol CA 5310 | 12.0 |
| Inventive polymer* | 459.2 |
| Total | 1060.7 |

*49% weight solids dispersion in water.

The coatings prepared in Examples 1-4 and Comparative Example 1 were tested for gloss according to the ASTM D523 test method and scrub resistance according to the ASTM D2486-17 test method.

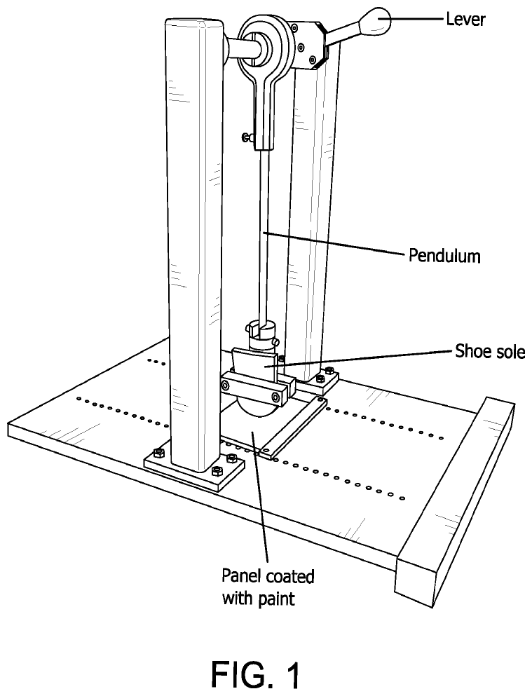

The coatings were also tested for mar and scuff resistance by scratching the surface with a plastic spoon, fork, and a black shoe sole. The plastic spoon and fork were dragged across the surface of the cured coatings and a visual rating of the scuffing was collected. The black shoe sole was scraped across the surface of the cured coatings using the pendulum swing equipment shown in FIG. 1. The results of the testing are provided in Table 3 below.

TABLE 3
Gloss, Scuff, and Mar resistance of Examples
1-4 and Comparative Example 1.

| | Exam- | Exam- | Exam- | Exam- | Comparative |
|---|---|---|---|---|---|
| | ple 1 | ple 2 | ple 3 | ple 4 | Example 1 |
| Gloss | | | | | |
| 20° | 14.1 | 13.2 | 9.8 | 12.9 | 7.4 |
| 60° | 48.5 | 46.6 | 43.8 | 48.2 | 47.6 |
| 85° | 79.9 | 77.2 | 79.4 | 82.1 | 85.6 |
| Plastic spoon | + | + | + | + | Control |
| mar resistance* | | | | | |
| Plastic fork mar | + | + | + | + | Control |
| resistance* | | | | | |
| Pendulum | + | + | + | + | Control |
| swing scuff | | | | | |
| resistance** | | | | | |
| Scrub resistance | 228 | 176 | 272 | 180 | 100% |
| (% of control) | | | | | (control) |

*Visual rating of the damage done to the coating.
+ Indicates improved mar and scuff resistance compared to the control paint.
**Visual rating of the intensity of the black mark left on the paint surface after cleaning with Kimwipes ™ available from Kimberly Clark.

1.-15. (canceled)

16. A polymer emulsion composition with a first and second stage comprising:
ketone or aldehyde group containing monomers and
a polyhydrazide containing crosslinker,
wherein the ketone to hydrazide functional group equivalent ratio is in the range of 1:0.6 to 1:1.5.

17. The polymer composition of claim 16, wherein the ketone containing monomers comprise diacetone acrylamide.

18. The polymer composition of claim 16, wherein the hydrazide containing cross-linker comprise adipic dihydrazide.

19. The polymer composition of claim 17, wherein the diacetone acrylamide monomers are present in an amount of 2.5 wt. % or greater based on the total weight of the composition.

20. The polymer composition of claim 18, wherein the adipic dihydrazide or polyhydrazide cross linkers are present in an amount of 0.8 wt. % or greater based on the total weight of the composition.

21. The polymer composition of claim 16, wherein the composition further comprises monomers selected from the group consisting of methyl (meth)acrylate, 2-ethyl (meth)acrylate, n-butyl (meth)acrylate, t-butyl (meth)acrylate, i-butyl (meth)acrylate, cyclohexyl(meth)acrylate, 2-ethylhexyl (meth)acrylate, i-bornyl(meth)acrylate, 2-octyl(meth)acrylate, styrene, (meth)acrylic acid, itaconic acid, sulfur acid monomers and phosphorous acid monomers.

22. The polymer composition of claim 16, wherein the weight ratio of the first stage polymer to the second stage polymer is from 50:50 to 97.5:2.5.

23. The polymer composition of claim 16, wherein the second stage polymer is present in an amount from 2.5 wt. % to 40 wt. % based on the total weight of the composition.

24. The polymer composition of claim 16, wherein the first stage polymer has a theoretical T_{g} of from −100° C. to 50° C.

25. The polymer composition of claim 16, wherein the second stage polymer has a theoretical T_{g} of from −50° C. to 250° C.

26. The polymer composition of claim 16, wherein the weight % ratio of the aldehyde or keto monomer of the first stage polymer to that of the second stage polymer is 1:10 to 1:0.5 based on the total monomer weight of the respective stages.

27. An architectural coating composition comprising the polymer composition of claim 16.

28. The architectural coating composition of claim 26, further comprising one or more of pigments, dispersants, fillers, coalescents, pH modifying agents, plasticizers, defoamers, surfactants, thickeners, biocides, co-solvents, and combinations thereof.

29. The architectural coating composition of claim 26, wherein the coating composition demonstrates at least one of the following properties:
(i) mar resistance when scraped with a plastic spoon
(ii) mar resistance when scraped with a plastic fork
(iii) scuff resistance when scraped with a rubber shoe sole as measured by a visual rating of the damage done to the coating.

30. A method of producing the multi-stage polymer emulsion composition of claim 16, the method comprising:
(i) producing a first stage polymer from a first pre-emulsion of monomers and initiator
(ii) producing a second stage polymer from a second pre-emulsion of monomers by feeding the second stage monomer pre-emulsion into the first stage polymer dispersion in the presence of a free radical polymerization initiator.
